(19) United States
(12) Patent Application Publication
(10) Pub. No.: US 2020/0343778 A1
(43) Pub. Date: Oct. 29, 2020

(54) ELECTRIC MACHINE

(71) Applicant: ABB Schweiz AG, Baden (CH)

(72) Inventors: Janne Roivainen, Helsinki (FI); Panu Hava, Espoo (FI)

(21) Appl. No.: 16/927,166

(22) Filed: Jul. 13, 2020

Related U.S. Application Data
(63) Continuation of application No. PCT/EP2018/050650, filed on Jan. 11, 2018.

(51) Int. Cl. H02K 1/18; H02K 5/15; H02K 5/24

(52) U.S. Cl. CPC H02K 1/185; H02K 5/24; H02K 5/15

(57) ABSTRACT

The electric machine includes a stator core with a longitudinal centre axis and a frame surrounding the stator core. The stator core is attached to the frame through four fastening points, wherein two fastening points are positioned at a first axial end of the stator core on opposite sides of the longitudinal centre axis and two fastening points are positioned at a second opposite axial end of the stator core on opposite sides of the longitudinal centre axis.

### FIELD

The invention relates to an arrangement in an electric machine comprising a stator core and a stator frame.

### BACKGROUND

Electric machines are subject to vibrations causing stresses on the equipment and on the joints in the electric machine. A common vibration problem of a 2-pole induction machine is known as twice-line frequency vibration. This vibration problem occurs when the twice-line frequency vibration from the stator coincides with a natural frequency of the machine. The vibration levels measured from the machine frame or from the end shields may exceed accepted levels defined in relevant standards.

There are different prior art methods for preventing twice-line frequency vibration. One possibility is to make the stator yoke thicker. This will result in an increase in the natural frequency of the stator core and in a decrease of the vibration of the stator core. Another possibility is to stiffen the motor frame and the end shields. This will also increase the natural frequency of the stator. Resonance between the natural frequency and the excitation may thus be avoided. Still another possibility is to limit the electro-magnetic forces of the stator through the electric design of the machine. Still another possibility is to support the stator core at the stator frame so that twice-line frequency vibration is minimized. The basic idea in the support between the stator core and the stator frame is to control the force transmission and coupling of vibration modes between the stator core and the stator frame.

These methods for limiting twice-line vibration in an electric machine may limit the performance of the electric machine as more material is required to stiffen the structure or the electric design is otherwise limited.

DE 92 00 502 U1 discloses an electric machine. The electric machine comprises a shaft and a radially directed central disc mounted on the shaft. An outer circumference of the disc comprises ring formed rotor poles coaxial with the shaft and extending axially outwards from opposite sides of the disc. The rotor poles comprises alternatingly permanent magnets and soft metal elements. Radially outwards from the rotor poles are outer stator poles and radially inwards are inner stator poles. The outer stator poles and the inner stator poles have windings that have a ring form and that are coaxial with the shaft. The casing comprises an inner casing and an outer casing. The inner casing encloses the outer and the inner stator poles. The inner casing is supported on the outer casing with bolts so that the outer ends of the bolts are positioned in a bushing formed in the outer casing. The bushing comprises an elastic material, whereby the elasticity of the elastic material is chosen so that the support between the inner casing and the outer casing is softer in the axial direction compared to the circumferential and radial direction.

U.S. Pat. No. 3,519,857 discloses a stator assembly for a dynamoelectric machine. The cylindrical shell of the frame is provided with radially inwardly extending ribs or bulkheads. Axially extending core bars are provided on the outer surface of the stator core. The stator core is attached to the frame with fasteners extending between the ribs or bulkheads and the core bars. A bolt passes through a locking bushing to a threaded hole in the core bar. A nut is further threaded on the locking bushing. The nut is welded to the rib or bulkhead. There are four fasteners at each end of the stator core i.e. eight fastening points all together.

WO 03/023941 discloses a shock-proof electric marine engine. The electric machine has a rotor and a stator in a housing. The support frame of the stator is supported with bearings on the support frame of the rotor. The support frames are supported with damping elements elastically on the shaft. The damping elements are axially fixed in ring formed flanges. The support frame of the stator is supported with damping elements on the casing. These damping elements comprise a rubber element which is mechanically connected with bolts to the support frame of the stator and the housing.

U.S. Pat. No. 3,375,382 discloses a dynamoelectric machine. The electric motor comprises a base having bearing brackets attached thereto and mounting bars connected to the base. A stator is mounted on the mounting bars and a rotor is positioned in the bore of the stator. A housing is positioned over the stator and rotor members. The ends of the mounting bars are supported on the end plates of the housing or on the support feet in the base. Two axially extending parallel grooves are formed on the outer surface of the stator core. The grooves are intended to fit on the mounting bars. The stator is clamped to the base and held in firm contact with the mounting bars by bolts attached to end plates to maintain the alignment of the stator.

The top of the stator is further attached with bolts to the housing.

### SUMMARY

An object of the present invention is to achieve an improved electric machine.

The electric machine is defined in the independent claims.

The electric machine comprises a cylindrical stator core with a longitudinal centre axis and a frame surrounding the stator core. The stator core is attached to the frame only through four fastening points, whereby two fastening points are positioned at a first axial end of the stator core on opposite sides of the longitudinal centre axis and two fastening points are positioned at a second opposite axial end of the stator core on opposite sides of the longitudinal centre axis, the stator core being in contact with the frame only through the four fastening points, the four fastening points being positioned in a horizontal plane.

The novel fastening arrangement between the stator core and the frame results in a controlled contact between the stator core and the frame. This makes it possible to accurately predict the vibration levels in the electric machine. The absolute vibration levels are also significantly lower compared to prior art fastening arrangements.

The novel fastening arrangement between the stator core and the frame makes it possible to allow harmful natural frequencies of the electric machine within the whole excitation frequency range. There are thus no restrictions in the speed range of the electric machine.

The novel fastening arrangement between the stator core and the frame does not impose any restrictions to the electric design of the electric machine.

The novel fastening arrangement between the stator core and the frame makes it possible to use a simple mechanical design of the electric machine.

The novel fastening arrangement between the stator core and the frame may in principle be used in any kind of electric machines. The fastening arrangement may, however, be used particularly in a 2-pole electric induction machine and more particularly in a 2-pole electric induction motor.

### DRAWINGS

In the following the invention will be described in greater detail by means of preferred embodiments with reference to the attached drawings, in which

FIG. 1 shows an electric machine,

FIG. 2 shows an axonometric view of a frame,

FIG. 3 shows a side view of the frame,

FIG. 4 shows an end view of the frame,

FIG. 5 shows a first cross sectional view of the frame,

FIG. 6 shows a second cross sectional view of the frame,

FIG. 7 shows a horizontal cross sectional view of the frame,

FIG. 8 shows the fastening of the stator core to the frame,

FIG. 9 shows an adapter support of the stator core,

FIG. 10 shows the vibration in a prior art support arrangement between the stator core and the frame,

FIG. 11 shows the vibration in the inventive support arrangement between the stator core and the frame.

### DETAILED DESCRIPTION

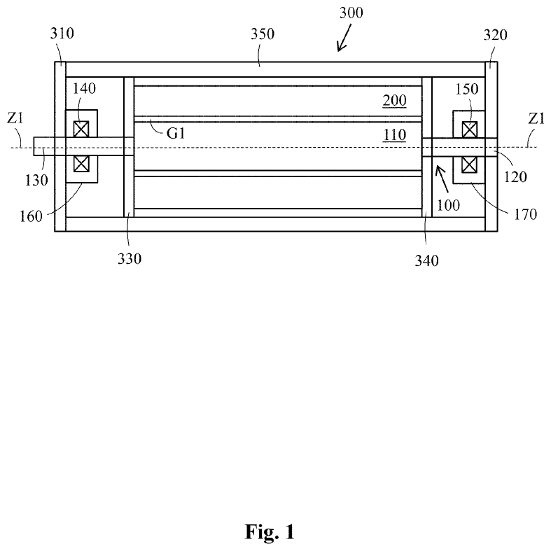

FIG. 1 shows an electric machine.

The electric machine comprises a longitudinal centre axis Z1-Z1, a cylindrical rotor 100 and a cylindrical stator core 200 surrounding the rotor 100.

There is an air gap G1 between the outer surface of the centre portion 110 of the rotor 100 and the inner surface of the stator core 200.

The rotatable rotor 100 may comprise a centre portion 110 and two end portions 120, 130 at each axial Z1-Z1 end of the centre portion 110. Each end portion 120, 130 of the rotor 100 may be supported through a bearing 140, 150 positioned in a bearing housing 160, 170.

The longitudinal centre axis Z1-Z1 forms a rotational axis of the rotor 100.

The stator core 200 may have a cylindrical shape provided with an inner bore receiving the rotor 100.

The frame 300 may comprise two opposite end shields 310, 320 positioned at each axial end of the frame 300 and a frame structure 350 extending between the end shields 310, 320. The frame 300 may further comprise an intermediate plate 330, 340 at each axial end of the stator core 200.

Each bearing housing 160, 170 may be supported on a respective end shield 310, 320.

The rotor windings and the stator windings are not shown in the figure. There may be one or more windings in the rotor and/or in the stator and/or there may be permanent magnets in the rotor and/or in the stator.

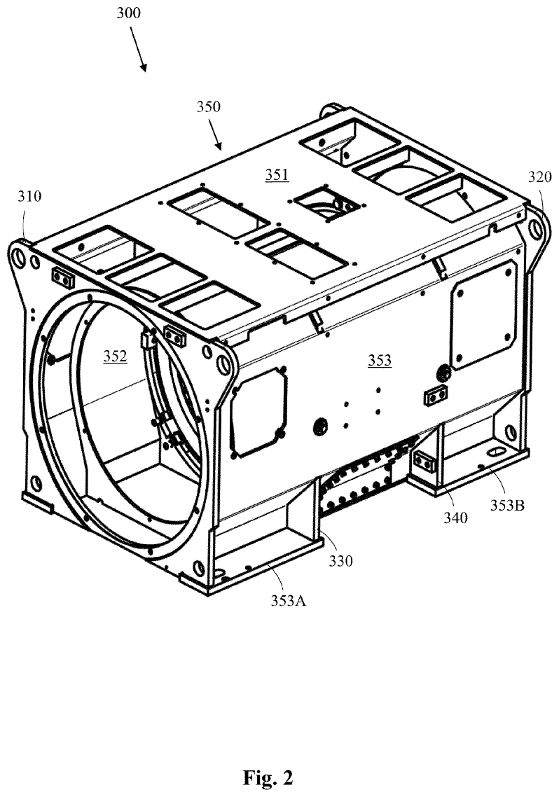

FIG. 2 shows an axonometric view of a frame.

The frame 300 may comprise two opposite end shields 310, 320 positioned at each axial end of the frame 200. The two opposite end shields 310, 320 are thus positioned at an axial distance from each other. The end shields 310, 320 may be attached to a frame structure 350 extending in the axial direction between the end shields 310, 320. Each end shield 310, 320 may comprise an annular opening through which the stator core 200 and the rotor may be pushed into the frame 300. The frame 300 may further comprise two intermediate plates 330, 340 positioned at each axial end of the stator core 200. The intermediate plates 330, 340 may also comprise an annular opening through which the stator core 200 and the rotor may be pushed into the frame 300. The frame structure 350 between the end shields 310, 320 may comprise an upper plate 351 and two opposite side plates 352, 353. The side plates 352, 353 may comprises foot portions 353A, 353B through which the frame 300 may be attached to a support structure. The upper plate 351 and the side plates 352, 353 may further comprise hatches allowing access to the interior of the frame 300. There may be further intermediate plates in the frame 300 between the end shields 310, 320.

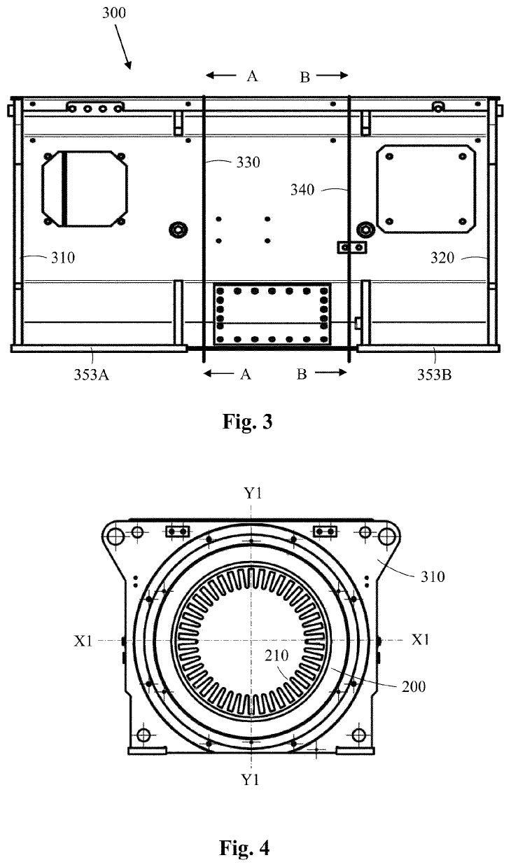

FIG. 3 shows a side view of the frame, and FIG. 4 shows an end view of the frame.

The side view shows the end shields 310, 320 and the intermediate plates 330, 340 within the frame 300.

The end view shows a horizontal centre plane X1-X1 and a vertical centre plane Y1-Y1 of the stator core 200.

The frame 300 surrounds the annular stator core 300.

The inner surface of the stator core 200 may be provided with slots 210 extending substantially radially outwards from the inner perimeter of the stator core 100. The slots 210 may receive a stator winding.

The stator core 200 may have a laminated structure i.e. it may be composed of annular sheets that are stacked together to form the stator core 200. Each sheet in the stator core 200 may be made of sectors, whereby the sectors may be attached to each other in order to form a closed perimeter. The stator core 200 may have a cylindrical form.

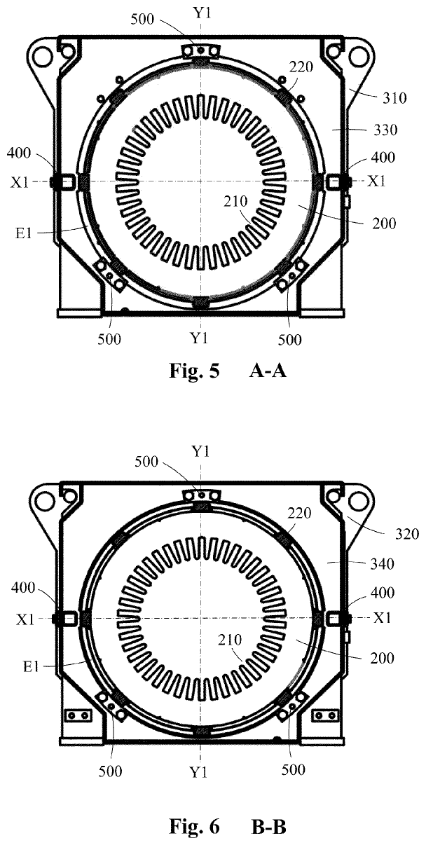

FIG. 5 shows a first cross sectional view of the frame in the direction of arrows A-A in FIG. 3 and FIG. 6 shows a second cross sectional view of the frame in the direction of arrows B-B in FIG. 3.

FIG. 5 shows the first stator end shield 330 and FIG. 6 shows the second stator end shield 340 positioned within the frame 300.

The stator core 200 may be provided with back beams 220 extending in the axial direction along the outer surface of the stator core 200. The back beams 220 may be attached by welding or by a compression joint or by a form lock to the outer surface of the stator core 200. The back beams 220 may be equally distributed along the perimeter of the stator core 200. The stator core 200 may comprise eight back beams 220 equally distributed along the perimeter of the stator core 200.

There may be a clearance E1 between the outer surface of the stator core 200 and the inner surface of the frame 330.

The stator core 200 may be supported with adapter supports 500 at the intermediate plates 330, 340 of the frame 300. The radial outer surface of the back beam 220 may be supported against the radial inner surface of the adapter support 500. There may be three adapter supports 500 at each end of the stator core 200. The adapter supports 500 may be distributed along the circumference of the stator core 200. A first adapter support 500 may be positioned in the uppermost point of the circumference of the stator core 200. The second and the third adapter supports 500 may be positioned in a respective lower quarter of the circumference of the stator core 200. The first adapter support 500 may thus be positioned in the vertical centre plane Y1-Y1 of the stator core 200. The second and the third adapter part 510 may be positioned symmetrically on opposite sides of the vertical centre plane Y1-Y1 of the stator core 200. The adapter supports 500 are used to position the stator core 200 in the correct position within the frame 300 before the stator core 200 is attached to the frame 300. The adapter supports 500 are removed when the stator core 200 has been attached to the frame 300. The adapter supports 500 will be described in connection with FIG. 9.

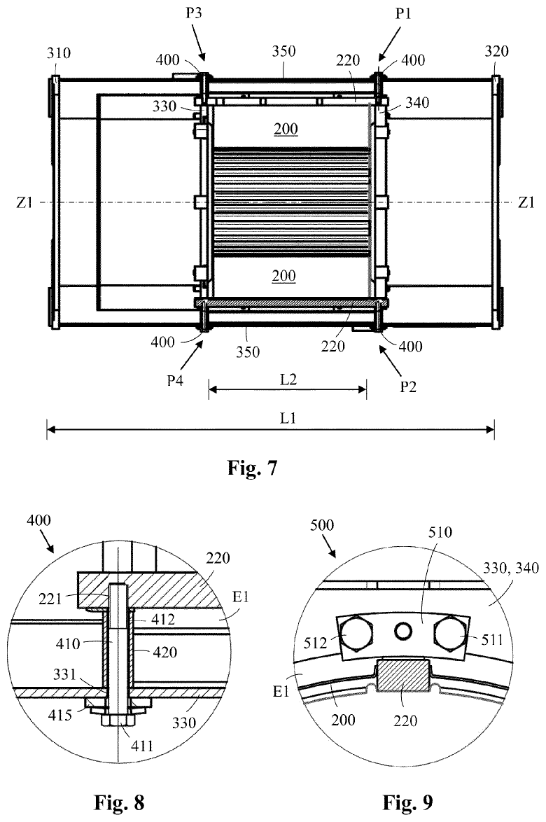

The stator core 200 may be attached with a fastening arrangement 400 to the frame 330. The fastening arrangement 400 may be located on the horizontal centre plane X1-X1 of the stator core 200. The fastening arrangement 400 will be described in connection with FIGS. 7 and 8.

FIG. 7 shows a horizontal cross sectional view of the frame.

The figure shows a longitudinal centre axis Z1-Z1 of the stator core 200.

The axial length L2 of the stator core 200 is only a portion of the axial length L1 of the frame 300. The bearing housings 160, 170 shown in FIG. 1 may be positioned within the frame 300 at both ends of the stator core 200. The first bearing housing 160 may be positioned between the first end shield 310 and the first intermediate plate 330. The second bearing housing 170 may be positioned between the second end shield 320 and the second intermediate plate 340.

The stator core 200 may be attached to the frame 300 through four fastening points P1, P2, P3, P4. There may be two fastening points P1, P2 at a first axial end of the stator core 200 i.e. in connection with the first intermediate plate 330 of the frame 300 and two fastening points P3, P4 at a second opposite axial end of the stator core 200 i.e. in connection with the second intermediate plate 340 of the frame 300. The first two fastening points P1, P2 may be positioned on opposite sides of the longitudinal centre axis Z1-Z1 of the stator core 200. The second two fastening points P3, P4 may also be positioned on opposite sides of the longitudinal centre axis Z1-Z1 of the stator core 200.

Each of the four fastening points P1, P2, P3, P4 may be located on a horizontal plane X1-X1. The horizontal plane X1-X1 may be a horizontal centre plane X1-X1 of the stator core 200. The horizontal centre plane X1-X1 may pass through the longitudinal centre axis Z1-Z1 of the stator core 200 i.e. through the rotational axis Z1-Z1 of the rotor 100. The fastening points P1, P2, P3, P4 may be positioned in the corners of a rectangle. One side of the rectangle may extend substantially along the first intermediate plate 330 and a second opposite side of the rectangle may extend substantially along the second intermediate plate 340. The two remaining opposite sides of the rectangle extend substantially along a respective longitudinal side of the frame 300. The longitudinal sides of the frame 300 may extend in the axial direction Z1-Z1 of the stator core 200.

The four fastening points P1, P2, P3, P4 may advantageously be positioned exactly in a horizontal plane X1-X1. A small deviation of one or several of the fastening points P1, P2, P3, P4 from the exact position is normally allowed without departing from the invention. The small deviation might be due e.g. to manufacturing tolerances. The four fastening points P1, P2, P3, P4 may thus be positioned substantially in a horizontal plane X1-X1.

Each of the four fastening points P1, P2, P3, P4 may comprise a fastening arrangement 400 attaching the stator core 200 to the frame 300.

There may be only four fastening points P1, P2, P3, P4 for fastening the stator core 200 to the frame 300. The stator core 200 may be in contact with the frame 300 only through the four fastening points P1, P2, P3, P4.

FIG. 8 shows the fastening of the stator core to the frame.

The fastening arrangement 400 may comprise a bolt 410 passing through a hole 331 in the frame 330 and further through a bushing 420 to a threading 221 in the back beam 220. The bushing 420 may extend between the frame 330 and the back beam 220. The bushing 420 may thus determine the clearance E1 between the back beam 220 and the frame 330. The outer end of the bolt 410 may comprise an outer threading 412 engaging with the inner threading 221 in the hole in the back beam 220. Washers 415 may be used under the head 411 of the bolt 410.

FIG. 9 shows an adapter support of the stator core.

Each adapter support 500 may comprise an adapter plate 510 which is attached with bolts 511, 512 to a respective intermediate plate 330, 340 in the frame 300. A radially outer surface of the back beam 220 may be seated against a radially inner surface of the adapter plate 510. The adapter plates 510 position the stator core 200 in a correct position within the frame 300 before the stator core 200 is attached to the frame 300. There are hatches in the upper plate 351 and in the side plates 352, 353 of the frame 300 through which the adapter plates 510 may be removed when the stator core 200 has been attached to the frame 300 through the four fastening points P1, P2, P3, P4.

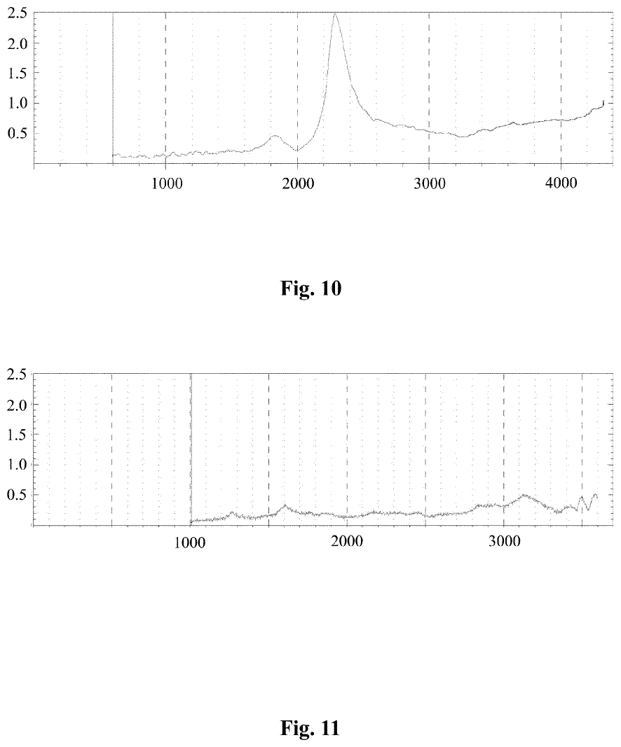

FIG. 10 shows the vibration in a prior art support arrangement between the stator core and the frame.

The vertical axis shows the amplitude of the vibration in mm/s (root-mean-square value) and the horizontal axis shows the rotational speed of the electric machine. The vibration is measured in the horizontal direction from the bearing housing. The figure shows that there is a peak of about 2.5 mm/s in the vibration at a rotational speed of about 2300 rpm.

FIG. 11 shows the vibration in the inventive support arrangement between the stator core and the frame.

The vertical axis shows the amplitude of the vibration in mm/s (root-mean-square value) and the horizontal axis shows the rotational speed of the electric machine. The vibration is measured in the horizontal direction from the bearing housing. The figure shows that the peak of about 2.5 mm/s in the vibration at a rotational speed of about 2300 rpm has been eliminated with the inventive support arrangement between the stator core 200 and the frame 300.

FIGS. 10 and 11 are measured from a two-pole induction motor.

A compression joint between two parts is advantageously achieved by using a bolt and a nut as fastening means. The bolt and the nut form a compression joint between the parts that are to be attached together. The compression joint could also be called a threaded joint when a bolt and a nut are used as fastening means. A compression joint could also be achieved e.g. with a heated rivet, which forms a compression joint between the parts that are to be attached together when the rivet cools down.

It will be obvious to a person skilled in the art that, as the technology advances, the inventive concept can be implemented in various ways. The invention and its embodiments are not limited to the examples described above but may vary within the scope of the claims.

1. An electric machine comprising a cylindrical stator core with a longitudinal centre axis and a frame surrounding the stator core, wherein the stator core is attached to the frame only through four fastening points, wherein two fastening points are positioned at a first axial end of the stator core on opposite sides of the longitudinal centre axis and two fastening points are positioned at a second opposite axial end of the stator core on opposite sides of the longitudinal centre axis, the stator core being in contact with the frame only through the four fastening points, the four fastening points being positioned in a horizontal plane.

2. (canceled)

3. The electric machine according to claim 1, that wherein a horizontal plane is a horizontal centre plane of the stator core.

4. The electric machine according to claim 3, wherein the horizontal centre plane of the stator core passes through the longitudinal centre axis of the electric machine.

5. The electric machine according to claim 4, wherein the attachment between the stator core and the frame is based on a compression joint in each fastening point.

6. The electric machine according to claim 5, which further comprises back beams extending in an axial direction between the axial ends of the stator core are attached to an outer surface of the stator core.

7. The electric machine according to claim 6, wherein the attachment between the stator core and the frame is in each fastening point arranged from the back beams to the frame.

8. The electric machine according to claim 7, wherein the attachment is arranged with bolts extending from the frame to the back beams.

9. The electric machine according to claim 8, wherein the bolts extend in the horizontal direction.

10. The electric machine according to claim 1, wherein the frame comprises two opposite end shields positioned at an axial distance from each other, a frame structure extending between the end shields, and two opposite intermediate plates positioned within the frame at the axial ends of the stator core, wherein the fastening points are arranged in connection with the intermediate plates.

11. The electric machine according to claim 10, wherein each fastening point comprises a fastening arrangement being formed of a bolt and a bushing extending between side plates in the frame structure and a back beam, the bolt passing through the respective side plate and the bushing to the back beam, whereby, wherein the stator core becomes attached to the frame through said bolts.

12. (canceled)

13. The electric machine according to claim 1, which further comprises back beams extending in an axial direction between the axial ends of the stator core are attached to an outer surface of the stator core.

14. The electric machine according to claim 13, wherein the attachment between the stator core and the frame is in each fastening point arranged from the back beams to the frame.

15. The electric machine according to claim 14, wherein the attachment is arranged with bolts extending from the frame to the back beams.

16. The electric machine according to claim 15, wherein the bolts extend in the horizontal direction.

17. The electric machine according to claim 3, which further comprises back beams extending in an axial direction between the axial ends of the stator core are attached to an outer surface of the stator core.

18. The electric machine according to claim 17, wherein the attachment between the stator core and the frame is in each fastening point arranged from the back beams to the frame.

19. The electric machine according to claim 18, wherein the attachment is arranged with bolts extending from the frame to the back beams.

20. The electric machine according to claim 19, wherein the bolts extend in the horizontal direction.

21. The electric machine according to claim 9, wherein the frame comprises two opposite end shields positioned at an axial distance from each other, a frame structure extending between the end shields, and two opposite intermediate plates positioned within the frame at the axial ends of the stator core, wherein the fastening points are arranged in connection with the intermediate plates.

22. The electric machine according to claim 21, wherein each fastening point comprises a fastening arrangement being formed of a bolt and a bushing extending between side plates in the frame structure and a back beam, the bolt passing through the respective side plate and the bushing to the back beam, wherein the stator core becomes attached to the frame through said bolts.
